(19) United States
(12) Patent Application Publication
(10) Pub. No.: US 2002/0143701 A1
(43) Pub. Date: Oct. 3, 2002

(54) Electronic bill presentment system with client specific formatting of data

(75) Inventors: Kellie Jo Maguire, South Berwick, ME (US); Gregory Park, Stratham, NH (US)

Correspondence Address: TIMOTHY P. O'HAGAN, P.O. BOX 1054, PORTSMOUTH, NH, 03802, US

(73) Assignee: Bottomline Technologies (DE) Inc., Portsmouth, NH

(21) Appl. No.: 10/014,378

(22) Filed: Dec. 11, 2001

Related U.S. Application Data
(63) Continuation-in-part of application No. 09/825,231, filed on Apr. 3, 2001.

(51) Int. Cl. G06F 17/60

(52) U.S. Cl. 705/40

(57) ABSTRACT

An electronic bill presentment and payment system for presenting an invoice of a vendor to a customer comprises a billing database for storing an invoice file. The invoice file comprises a line value representing an amount payable by the customer for a product provided by the vendor, a tax value representing an amount payable as a tax on the product, and a fee value representing an amount payable as a fee on the product. An application server provides for receiving a request to adjust the line value from the customer, providing instructions to replace the line value with an adjusted line value, calculating an adjusted tax value and an adjusted fee value based on the adjusted line value, and providing instructions to replace the tax value with the adjusted tax value.

### TECHNICAL FIELD

The present invention relates to a financial transaction system and method, and more particularly, to an improvement for a network-based system and method for adjustments in billing and payment.

### BACKGROUND OF THE INVENTION

Historically, a purchaser of goods or services orders them from a vendor, to whom the customer agrees to pay a specified price. The vendor then provides the customer the goods ordered, along with an invoice. The amount invoiced should equal the amount which the customer agreed to pay. To ensure this, invoice presentment and bill payment procedures have always involved a few steps. First, that the vendor deliver (or present) an invoice to a customer. Thereafter, the customer reviews the invoice, to make sure, for example, that the goods and services listed on the invoice were those actually delivered or performed, that the charges for each were correct, and that any taxes, fees, or additional surcharges based on the same had been computed correctly and added correctly into the total amount due. If everything was in order, the customer would typically send a check to the vendor. In most cases, invoice payment was a perfunctory act—and quite suitable for automation Indeed, some time ago, first generation electronic bill-payment systems which fully automated this process, in its simple case.

However, if, upon reviewing the invoice, the customer noticed an error, he would notify the vendor that the invoice needed “adjustment”. Negotiations would be held between personal representatives of the vendor and personal representatives of the customer, resulting in the customer and vendor agreeing to an “adjustment” and each appropriately making appropriate adjustments in their respective business's accounting systems.

To solve this lingering problem, second-generation invoice presentation and payment systems were developed which may also automate, not only the presentation and payment of fixed invoices, but also automate the disputation of invoice data such as quantity, unit cost, total price, etc, and, where appropriate, automate the adjustment of such invoice datum or data. Automatic adjustment works as follows: upon examining a mill or invoice, a customer may propose invoice adjustments on-line to the invoice presentation system. If the character or type of the adjustment(s) ones which were agreed to in advance by the vendor and customer, the invoice presentation system may automatically make the adjustment, and ideally, complete the transaction. Ordinarily, at that time the invoice presentation system would notify the vendor that an adjustment had been made, for reasons including the prevention of fraud and facilitating the reconciliation of accounting records.

Unfortunately, even with the addition of automated adjustments to the automated payment process, closing even an automatically paid and automatically adjusted transaction would still often require manual intervention. This is because the adjustment of the quantity or price of the goods or services invoiced will typically also require adjustment of numerous ancillary fees or charges which are incidental to the transaction and which often have a complex dependence on the quantity or price of the goods or services invoiced. Two common examples of such ancillary items are taxes, which are often dependent on sales price, and delivery charges, which depend on quantity delivered. It is readily seen that if a system accepts an adjustment to a base line item of an invoice, the invoice must be further adjusted to reflect the change in the amount of the ancillary item, which usually will need to be changed due to the line item adjustment. Only then can the transaction be considered closed. No known currently available systems perform this step efficiently, if at all.

While, for purposes of brevity, examples given herein are largely concerned with ancillary items which have a value which is are directly dependent upon a base line item value, it will be apparent to those of ordinary skill in the relevant arts that the present invention of course extends to cases in which the value of an ancillary item (referred to as the “child”) is indirectly dependent upon a base line item value, in that it depends directly upon another ancillary item (referred to as the “parent”) which itself depends directly upon a base line item value. In such a case, of course, an adjustment to the base line item value will cause adjustments in the “parent” and “child” ancillary items, while the adjustment of a “parent” ancillary item may cause an adjustment only in the “child” ancillary item, not in the base line item value upon which the parent depends. Similarly, it will be apparent to those of ordinary skill in the relevant arts that there may be any number of a plurality of “generations” which may be handled by the present invention; accordingly, and again in the interests of brevity, these “multi-generational” dependencies are not depicted herein, it being understood that the current disclosure, particularly with the instant paragraph, adequately discloses how the present invention handles “multi-generational” dependencies.

And so, for transactions which would otherwise be automated, due to ordinary and even adjusted payments having been automated, closing a transaction would still require personal representatives of the vendor and personal representatives of the customer(s) to expend considerable time and effort to perform the recalculation (and adjustment) of ancillary items taxes, fees, and charges necessitated by adjusting the base line item(s) on an invoice. It should be appreciated that the (re)calculation of these ancillary items is often quite complex, particularly for a transaction involving the provision of a highly regulated and taxed substance, such as aviation fuel, where, the calculations necessary to adjust these ancillary items are often quite complex, involving, for example, sliding tax scales, or on taxes that vary due to geography and multiple jurisdictions, and transaction-specific delivery fees and charges.

As such, there is a need for an invoice presentment system that does not suffer the disadvantages discussed above, and in fact overcomes them, by fully automating the invoice presentment and payment process, including having means for performing the automatic adjustment of ancillary line items (e.g. taxes and/or fees) made necessary by an automatic adjustment of invoice base line items, so that a transaction may be closed in fully automated fashion.

### SUMMARY OF THE INVENTION

The present invention is to provide an automatic electronic bill presentment and payment system with added functionality including automatic adjustment of an invoice made when an invoice presented for payment has a disputed value in its base line item (e.g. quantity or unit price) (sometimes referred to herein as line value) and further including automatic adjustment of the invoice's ancillary line items (e.g. taxes and/or fees) (sometimes referred to herein as tax value or fee value (respectively)) such as may be made necessary by the adjustment of the invoice due to the adjustment of the base line items. In a first embodiment, the biller system (and the payer system) may be configured with a manual user interface which enables a human user to both enter and obtain data and which is configured to exchange data with the electronic bill presentation and payment processing system using HTML. In a second embodiment, the biller system (and the payer system) may be configured to exchange transactions directly with the biller accounting system (or the payer accounting system) using a transaction definition compatible with such system and configured to exchange data with the electronic bill presentation and payment processing system using XML.

### BRIEF DESCRIPTION OF THE DRAWING

FIG. 1 is a block diagram of an electronic bill presentment and payment system, and associated systems, consistent with the present invention;

FIG. 2a is a diagram illustrating exemplary operation of a client workstation in accordance with one embodiment of the invention;

FIG. 2b is a diagram illustrating exemplary operation of a client server in accordance with one embodiment of the invention;

FIG. 3 is a diagram illustrating the operation of a plurality of IBSPs and a plurality of EBPPs and other service systems in accordance with another embodiment of the invention;

FIG. 4 is a state diagram illustrating simultaneous-session server operation;

FIG. 5 is a chart listing exemplary adjustment rules in accordance with the practice of the current invention;

FIG. 6 is an illustration of tax and service fee calculation data used in connection with the current invention.

FIG. 7 is a state diagram illustrating examination of invoice, examination of invoice (detailed) and adjustment of invoice, all in accordance with the present invention.

FIG. 8 is a workflow diagram illustrating the automatic adjustment of an invoice, in accordance with the present invention.

FIG. 9 is a sample invoice for the sale of Aviation Fuel, which bears an error which will require its adjustment utilizing the method and system of the present invention.

FIG. 10 is a sample invoice for the sale of Aviation Fuel which was given in FIG. 9, adjusted utilizing the method and system of the present invention.

### DETAILED DESCRIPTION

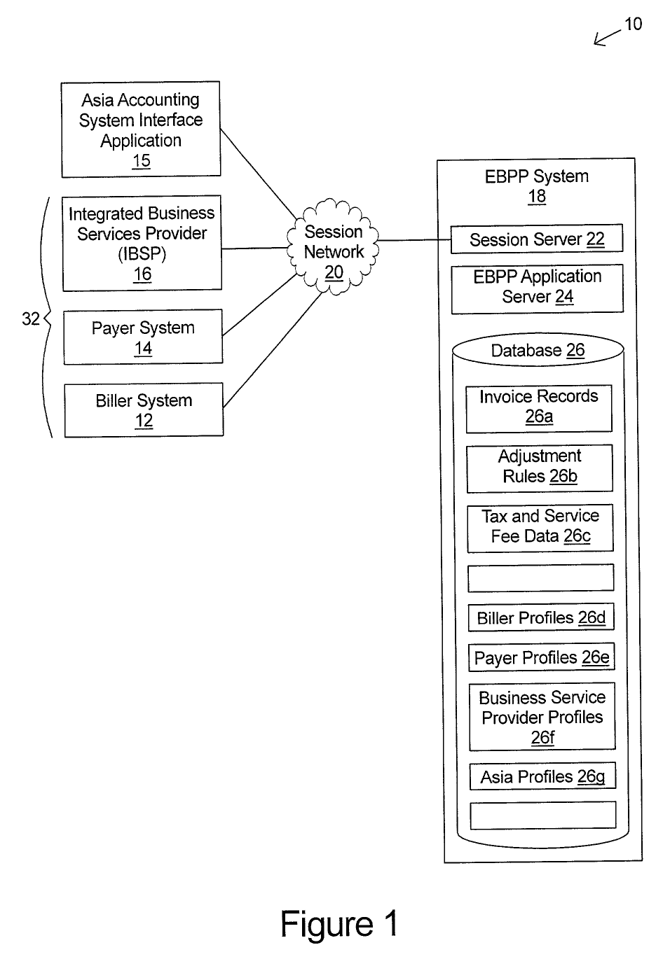

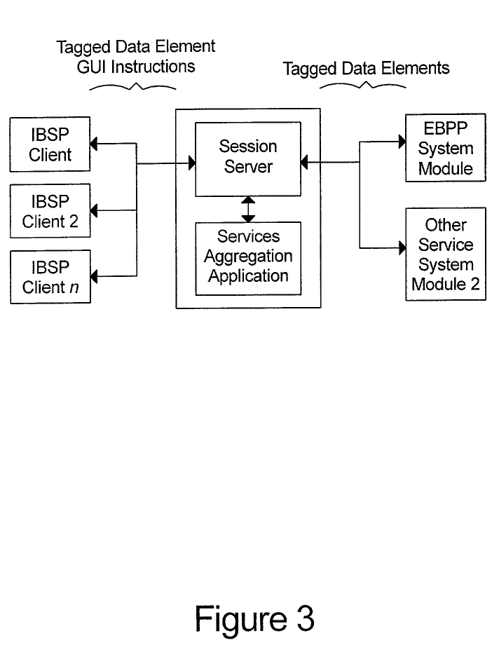

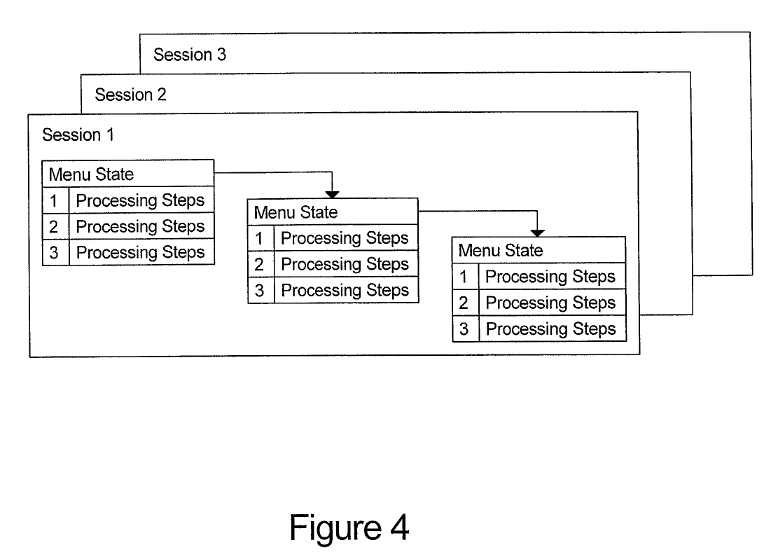

FIG. 1 illustrates an Electronic Bill Presentment and Payment (EBPP) system 10 of the present invention. System 10 may comprise at least one BILLER SYSTEM 12, at least one PAYER SYSTEM 14, an ACCOUNTING SYSTEMS INTERFACE APPLICATION (ASIA) 15, AN INTEGRATED BUSINESS SERVICES PROVIDER SYSTEM (IBSPs) 16, and an ELECTRONIC BILL PRESENTMENT AND PAYMENT (EBPP) MODULE 18, all in communication with one another via a SESSION NETWORK 20, which may comprise Internet or private networking. It should be appreciated that each of the BILLER SYSTEM 12, PAYER SYSTEM 14, and IBSP 16 are most typically operating as or on computers or “workstations” remotely located from each other and from EBPPS 18 and that the may be controlled by separate entities. Alternatively, they may, in whole or in part, be commonly controlled and/or located at a single entity. Note further that a plurality of IBSPs may be operated with a plurality of EBPP modules, as shown in FIG. 3.

EBPP MODULE 18 comprises the following subsystems: SESSION SERVER 22, which connects the EBPP MODULE 18 to other systems via SESSION NETWORK 20; the EBPP DATABASE 26, and the EBPP APPLICATION SERVER 24. EBPP DATABASE 26 has storage which comprises all the data necessary to the function of the EBPP SYSTEM 18, including but not limited to INVOICE RECORDS 26a, Adjustment Rules 26b, Tax & Service Fee Data 26c, BILLER PROFILES 26d, PAYER PROFILES 26e, BUSINESS SERVICE PROVIDER PROFILES 26f, and ASIA PROFILES 26g. EBPP APPLICATION SERVER 24 may comprise means for receiving a request to adjust an invoice line item value from the customer, and means for providing instructions to replace the line item value with an adjusted line item value, and means for calculating an adjusted tax value based on the adjusted line item value, and means for providing instructions to replace the unadjusted ancillary item value with the adjusted ancillary item value.

Note that one or more of BILLER SYSTEM 12, PAYER SYSTEM 14, ACCOUNTING SYSTEMS INTERFACE APPLICATION (ASIA) 15, and INTEGRATED BUSINESS SERVICES PROVIDER (IBSP) 16 each comprise computing devices with appropriate hardware and software for interfacing with IBSP 18, and that they may, via SESSION NETWORK 20, interface with EBPP MODULE 18. The BILLER SYSTEM 12 and PAYER SYSTEM 14 may comprise computing devices with appropriate hardware and software for interfacing with EBPP 18.

Recall that one of the fundamental operations of EBPP SYSTEM 10 is to enable the automatic payment of bills. Generally speaking, this is accomplished after billing data (e.g. invoices) have been transmitted from BILLER SYSTEM 12 via SESSION NEWORK 20 to EBPP MODULE 18, and has been stored in EBPP DATABASE 26. Once one or more invoices has been so stored, PAYER SYSTEM 14 may, via SESSION NETWORK 20, connect with EBPP MODULE 18, and effectuate the payment of invoices in a manner discussed in further detail elsewhere herein.

One important aspect of the system of the present invention is that it may operate in one of two ways, i.e. (1) “manually”, e.g. by an human operator manually, e.g. by manual data entry into browsers running on a Payer System 14 workstation or an a Biller System 12 workstation, with data to be passed from the browsers to EBPP MODULE 18 to as hypertext markup language (HTML) code, or (2) “automatically”, as by automatic data transfers, as extensible markup language (XML) code, between EBPP MODULE 18 between PAYER SYSTEM 14, BILLER SYSTEM 12, and/or ASIA 15.

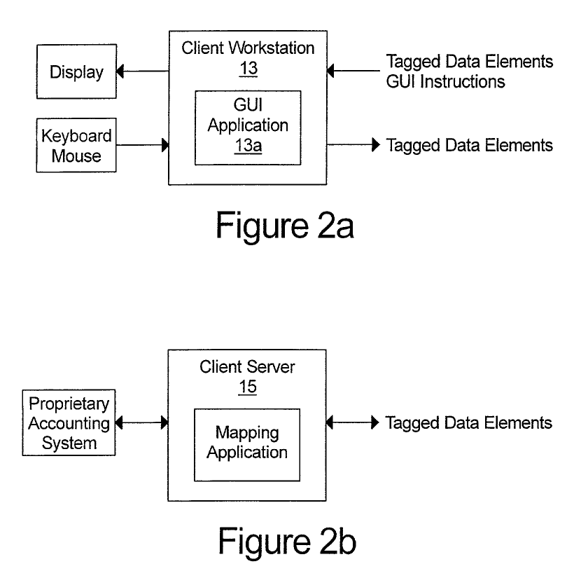

A diagram illustrating manual operation is given in FIG. 2a, which illustrates a client workstation 13, running a GUI application 13a, e.g. a browser application such as are well known to those skilled in the relevant arts.

A diagram illustrating automatic operation is given in FIG. 2b, which may be understood with respect to BILLER SYSTEM 12 and/or a PAYER SYSTEM 14 may have their functions performed by an ACCOUNTING SYSTEM INTERFACE APPLICATION (ASIA) 15 which will communicate with the EBPP MODULE 18 e.g. by utilizing XML. Such an ASIA 15 can eliminate the need of the BILLER USER of BILLER SYSTEM 12 or a PAYER SYSTEM USER PAYER SYSTEM 14 to manually enter data input to (or output from) an accounting system. More specifically, XML messages conveying that data may be used to automatically convey that data in or out of ASIA 15. Those of ordinary skill in the art will recognize that such data may be generated by one of any number of commercially available billing systems, e.g., SAP, Oracle Financials, JD Edwards, People Soft, Great Plains, etc. The data outputted by these billing systems and input into the system may come in a variety of formats including raw data, print file format, and X-12 ANSI 810 (EDI) (and its predecessor or successor standards, as well as comparable standards).

In another alternative embodiment of the present invention, the INTEGRATED BUSINESS SERVICES PROVIDER (IBSP) 16 may be an exchange or other service bureau application providing a plurality of business data processing services, one of which is EBPP, in accordance with the present invention. In such an embodiment, IBSP 16, from the point of view of PAYER SYSTEM 14 or BILLER SYSTEM 12 essentially.

Acceptable data formats may be, for example, of the formats such ANSI X12 810, flat ASCII files, etc., as well as of well formed XML schemas. There are also industry-specific standards. In the area of purchasing aviation fuel, for example, the American Petroleum Institute (www.api.orq) has codified standard formats for invoices and has published these standards as “Publ 3800, AVNET—Electronic Document Formats for Aviation Fuel Sales.” According to the American Petroleum Institute, this “. . . includes instructions for implementing electronic formats for aviation fuel invoices, delivery tickets, price notifications, and electronic payment/remittance advice transactions sets. Conventions for the use of these documents encompass both the American National Standards Institute (ANSI) ASC X12 EDI format and the United Nations EDIFACT (UN/EDIFACT) standard.”

According to the presently preferred embodiment, a one or more databases/servers used herewith may be an OLTP (on-line transaction processing) system, embodied in a server, such as Microsoft Structured-Query Language (SQL) Server 7™ or another OpenDatabase Connectivity (ODBC)—compliant database. EBPP DATABASE 26 may well be a “relational database”, the theory and operation of which are well-known to those of ordinary skill in the relevant art.

The contents of the various databases are as follows: INVOICE RECORDS 26a comprise sets of data fields specific to each invoice, and may, in a presently preferred embodiment, comprise data as specified in “American Petroleum Institute 3800, AVNET—Electronic Document Formats for Aviation Fuel Sales”, the entire contents of which are hereby incorporated by reference' and which are available through the website at www.api.org. ADJUSTMENT (DISPUTE) RULES 26b contains the rules governing adjustments (disputes); note that some of these rules may be payer-specific (i.e. making the governing rules different for different customers) or may be applied globally to all payers. These rules most typically define allowable adjustments in qualitative fashion, e.g. by stating, for example, the fields that are adjustable. TAX AND OTHER ANCILLARY ITEM DATA 26c may comprise data such as tax tables and delivery fee schedules, etc. PAYMENT RECORDS 26d comprises records relating to data such as payments made, the current state of a payment, and the status history of the payment (which may track any changes made to a payment record, as well as the identity of who made the changes. BILLER PROFILES 26d and PAYER PROFILES 26e respectively contain biller-specific and payer specific data, e.g. name, address, identity of the party or parties responsible for billing or payment, etc.; e.g., data which one of ordinary skill in the relevant arts might commonly expect to find on the header of an invoice or payment transfer. BUSINESS SERVICE PROVIDER PROFILES 26f contain similar profile data for one or more third-party IBSPs 16, and ASIA PROFILES 26g contains data relevant to each third-party accounting system (not shown for clarity and brevity) with which EBPP SYSTEM 10 might be operated with.

Biller System Operation

Operation of the BILLER SYSTEM 12 may be better understood with reference to the figures, as well as to the specification and all appended claims.

Before the first use of the EBPP SYSTEM 10, the user of BILLER SYSTEM 12 will create a BILLER PROFILE which will be stored at BILLER PROFILES DATABASE 26d. BILLER PROFILE DATA (which the system may be adapted to store as global information on the database) will comprise information such as the following: name, address, city, state, zip, country, SIC code, TIN, and default template type.

The user of BILLING SYSTEM 12 enters into a workstation the specifics of each and every individual invoice which is intended for payment by a particular payer. Note: those skilled in the relevant arts will notice that operation, for example purposes, is discussed with reference to manual operation, it is readily understood that automatic operation would proceed in very similar fashion, with the functions of BILLING SYSTEM 12 and PAYER SYSTEM 14 being performed by automata, e.g., ASIA 15). These invoice specifics include all necessary accounting information corresponding to the commercial transaction which the invoice covers; this information is known to those skilled in the relevant arts and may include invoice-specific data received from the BILLER SYSTEM 12. Every invoice entered into BILLER SYSTEM 12 is transmitted to EBPP MODULE 18 though SESSION NETWORK 20. Invoice data is stored on INVOICE RECORDS 26a and will include all data from the invoice, including but not limited to all line items, unit prices, quantities, purchase orders, dates of order, dates of deliver, purchase order numbers etc. Invoice data will be stored there while it waits to be accessed by the payer, as will be explained further herein.

However, in accordance with a feature of the present invention, the biller may monitor the “progress” of each invoice as it makes its way through each “gatekeeper” in the payer's invoice review and approval process. This is because the system not only provides simple invoice presentment, but also automates routing the invoice through a customer's multi-level (invoice) approval process, while providing certain status information to the vendor to assist the vendor in its cash management. Status information is provided to the vendors (billers) through the web interface, and may use emails for certain important status events and some reporting. After approval by the first gatekeeper person, the system will notify the second gatekeeper person. The system will one after another, notify every gatekeeper person (examples of which are given later herein) in the invoice-approval process that an on-line invoice requires their approval. The pattern continues until the process is complete and the customer schedules invoice payment to be made on a specified date. Notably, an advantage of the presently preferred embodiment is that the biller may, through requests made to EBPP module 18, track invoice payment status from the time of presentment right through the time of payment.

Payer System Operation

Operation of the PAYER SYSTEM 14 may be better understood with reference to the figures, as well as to the specification and all appended claims.

Before the first use of the EBPP SYSTEM 10, the user of PAYER SYSTEM 14 will create a PAYER PROFILE which will be stored at PAYER PROFILES DATABASE 26e. BILLER PROFILE DATA (which the system may be adapted to store as global information on the database) will comprise information such as the following: name, address, city, state, zip, country, SIC code, TIN, and default template type.

Each PAYER SYSTEM 14 user logs in to the PAYER SYSTEM 14, which may display a biller list, which may include all biller that the payer has a relationship with in the EBPP system 10. The EBPP system 10 may permit the PAYER SYSTEM user to click on any biller to get a list of invoices from that biller.

The user of the PAYER SYSTEM 14 (which may, as explained elsewhere, be either human or computer, will select selects invoices which he (or it) wishes to pay. The EBPP MODULE 18 will, via the software running an EBPP APPLICATION SERVER 24, generate and provide to the PAYER SYSTEM 14 user an invoice list page displaying invoices which meet the selection criteria.

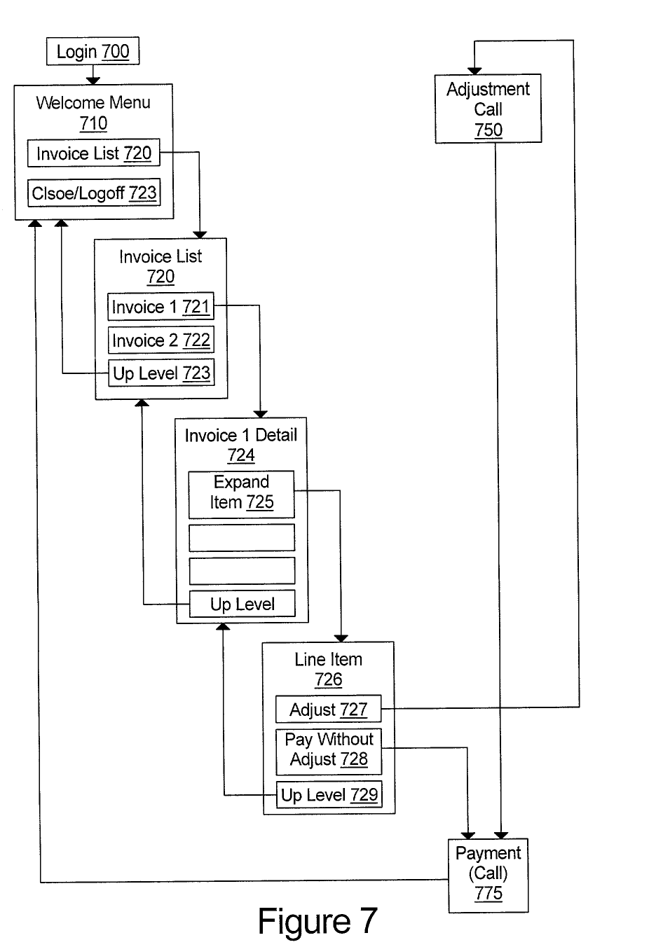

Once the payer user logs in (700) he (or it) is presented with a welcome menu, as the web server executes code representing a hierarchy of work flow menus that are presented to the operator (user) of the biller system through the open session. The web server transitions between states in accordance with operator selections of menu items as detected through the open session. This is depicted at to FIG. 7, which is a state diagram showing how the payer user may navigate through various display screens. Note that the payer system user is first presented with welcome menu 710, which contains on it invoice list 720. As the user selects invoice 1 (at 721), he is presented with Invoice 1 detail (at 724), which offers a choice to explode line item (at 725); once the user selects that choice workflow proceeds and he is presented with a Line Item Workflow Menu (at 726). From the Line Item Workflow Menu the user may select [line item] adjustment (at 727], or payment of the invoice without adjustment [at 728] or “UpLevel” at 729. Should the user select “pay without adjustment” (at 728) then the item is paid, al databases are updated and payments reconciled and recorded, and control returns to invoice list 720. However, should the user select to adjust the invoice line item, (at 727), control passes to an “Adjustment Call” (at 730); before control returns to invoice list 720, the functionality of the “Adjustment Call” must be performed.

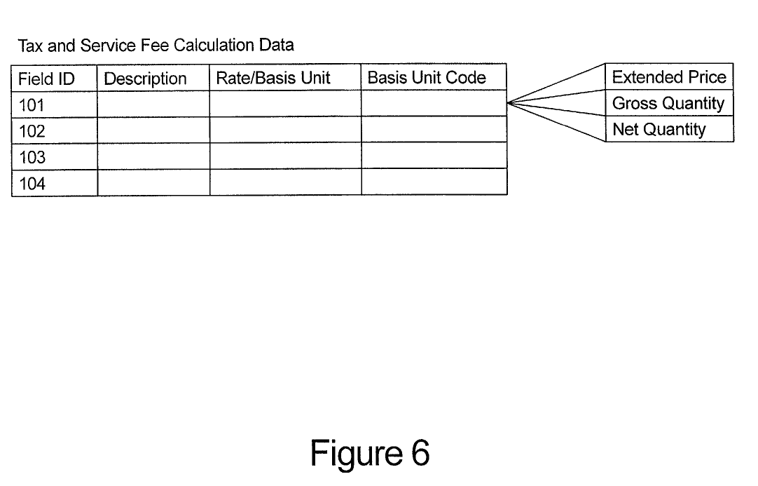

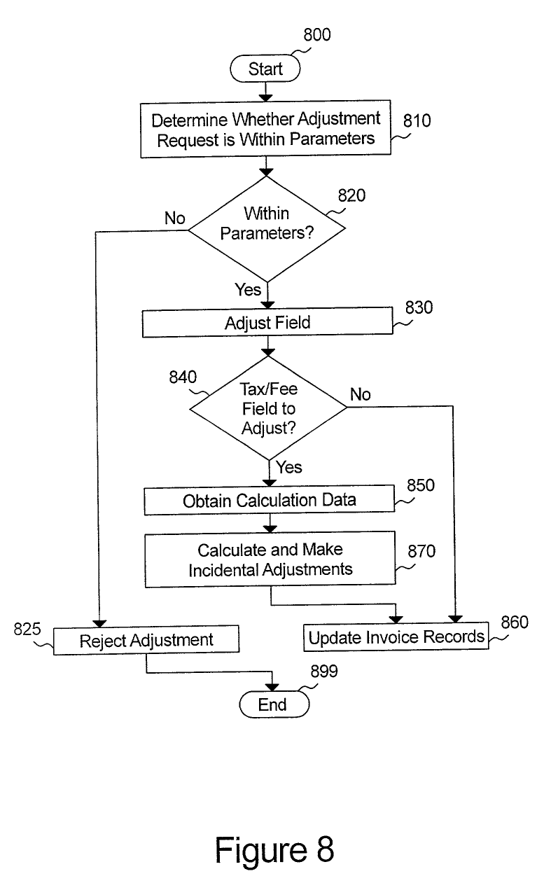

The functionality of “Adjustment Call” 720 is flowcharted in FIG. 8. Referring now to FIG. 8, note that the flowchart starts at 800. An initial check as to whether the adjustment request is within acceptable parameters (stored at adjustment database 26b) is made at branch 820. If the adjustment request is NOT within acceptable parameters, control passes to the “reject adjustment” step at 825, and thence to the end at 899. If the adjustment request IS within acceptable parameters, control passes to the “adjust field” step at 830, and the field is adjusted. Next, a conditional check is performed at step 840, to see whether the previously made adjustment necessitates a separate adjustment of ancillary line items, e.g. tax/fee fields. In making this check, reference is made to [ancillary] tax and service fee database 26c (in FIG. 2) an exemplary structure of which is illustrated at FIG. 6. If the answer to the conditional check is “no”, then no separate adjustment is made, control passes to “update invoice records” at 860, and thence to the end at 899. If, however, the answer to the conditional check is “yes”, then control passes to “obtain calculation data” at 860, and next to “calculate and make incidental (ancillary line) adjustments” at 870, control passes to “update invoice records” at 860, and thence to the end at 899. In all cases, once control has passed to the “Adjustment Call” end at step 899, control then passes (as shown in FIG. 7) to the “Payment Call” step at 775, which effectuates payment in any of a number of ways which are-well known to those of ordinary skill in the relevant arts, and then returns control back to the Welcome Menu (710), which may comprise an invoice list (at 720) and a close/logoff function option (723).

Exemplary pre-defined payer profiles (which may be stored as global information on the database) may comprise the following exemplary types of “gatekeeper” people:

Security Administrator: May have all payer profile and administration permissions, including the ability to set-up and delete ID's, bank accounts and the payer profile itself. The system may not allow this ID to be connected to any billers or any processing permissions. The system may permit this ID access to the security administration report only. The system may permit this ID only to be set-up by the system SuperUser.

Receiving Supervisor: May be provided with a button called “adjust an invoice”. With this new button, the system may permit a receiving administrator to be able to review an invoice and make changes. However, the system may restrict change permissions to quantity adjustments only. The system may link or map this type of ID to an individual biller or group of billers.

Purchasing Manager: May be provided with the buttons for list all invoices; approve invoices (keeping all adjustment capabilities intact); pending payments without the cancel payment privilege; invoice history and biller directories. The system may permit all these permissions to be filtered by biller if the ID were assigned to a particular biller or subset of billers.

Payables Administrator: May have permissions for initiate payments, with one new feature, the ability to create a general invoice adjustment only prior to creating a payment order; pending payments without the cancel payment privilege and payment history. The system may permit all these buttons to be filtered by bank account and biller if the ID were assigned to a particular subset of bank accounts and/or billers. The system may assign this ID the following reports: return items.

Payables Manager: May have permissions for authorize payments; pending payments with cancel payment permissions; payment history; invoice history; payer profile and biller directories. The system may allow this role to be filtered using dollar amount and may assign this ID the following reports: return items.

Controller: May have permissions for list all invoices; pending payments without cancel payment permissions; payment history; and invoice history. The system may assign this ID the following reports: cashflow forecasting; outstanding invoices; discount management; adjusted invoice history and security administrator

Cash Manager: May have permissions for pending payments without cancel payment permissions. The system may assign this ID the following reports: cashflow forecasting report.

Payables Systems Administrator: May be responsible for managing the daily file export routine for both unpaid invoices and payments.

To further understand the advantages of the operation of the present invention, consider now an invoice adjustment for a product such as aviation fuel. A typical invoice adjustment will require at least two individual adjustments to the invoice. The first adjustment to the line item amount associated with the goods or services and a second adjustment to the tax line item(s) associated with the goods or services.

However, sometimes more than two adjustments are required, such as when multiple taxing jurisdictions are involved, or when there is a variable rate “tax table” involved, or when flat fee surcharges are involved, e.g. in the course of the sale of some products such as, for example, aviation fuel. Aviation fuel is most commonly sold from a mobile truck at multiple locations, e.g. various points on the tarmac adjacent the aircraft to be fueled. In an instance such as this, a truck full of aviation fuel may leave its depot and proceed to a plurality of aircraft, dispensing all or only some of its contents to the aircraft. Regardless of the amount dispensed, however, there will be a flat delivery fee associated with the driving the fuel truck out to each aircraft for fueling. Of course, there is also the base charge per gallon of aviation fuel—a charge which itself may vary day to day according to spot price, quantity dispensed, aggregate quantity purchased by the aircraft operator, etc. and there are Federal, State, and local taxes which vary according to where the plane is refueled—a locality which in some instances may differ from where the refueling truck was filled. It should be clear to the reader that the “Grand Total” on an invoice for aviation fuel is the sum of many terms, that the computation of net amounts due incident to refueling operations are not easy. And truly complex is the computational work necessitated when an aviation fuel purchaser disputes an invoice; and recalculations for the entire disputed invoice must be done, and the results reconciled so as to ensure proper billing and compliance with tax laws and various governmental regulations.

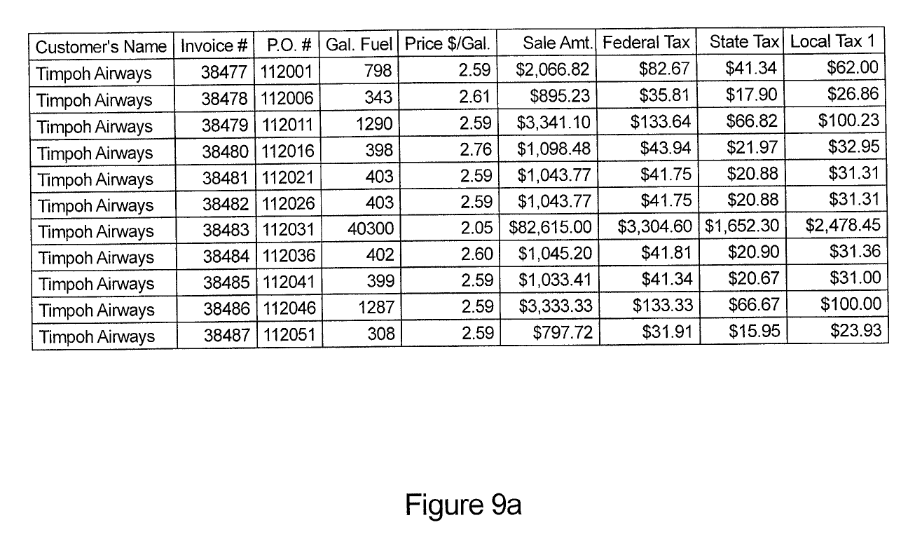

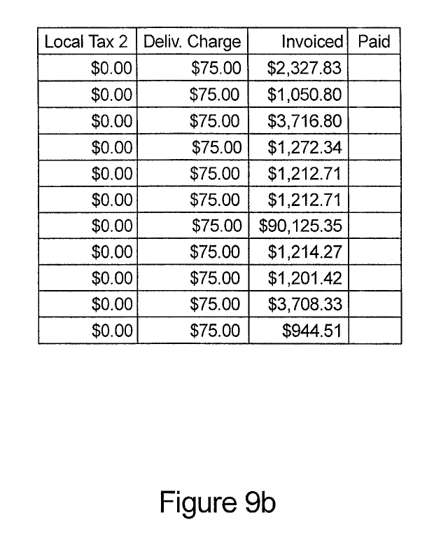

Reference is now made to FIG. 9, which depicts a sample invoice for the sale of Aviation Fuel. As will be made clear from the discussion herein, this invoice bears an error which will require its adjustment utilizing the method and system of the present invention. This invoice governs a number of fuel sales to an executive jet charter company called “Timpoh Airways”. Note that Timpoh Airways purchase relatively modest amounts of fuel—with the striking aberration of one gigantic purchase of 40,300 gallons, as shown in FIG. 9).

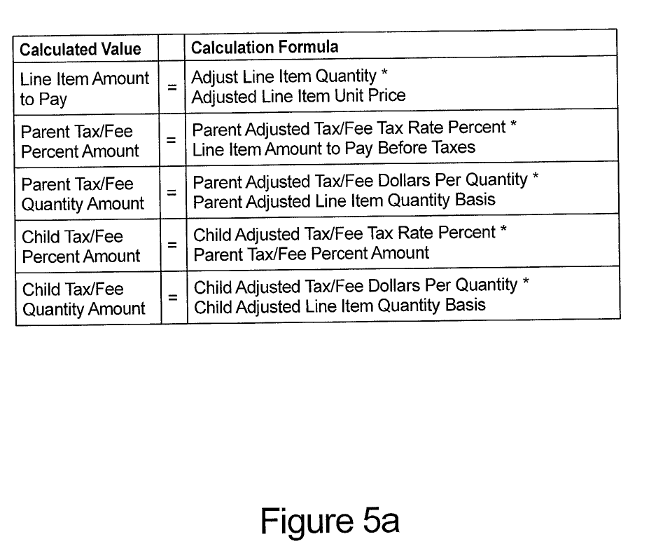

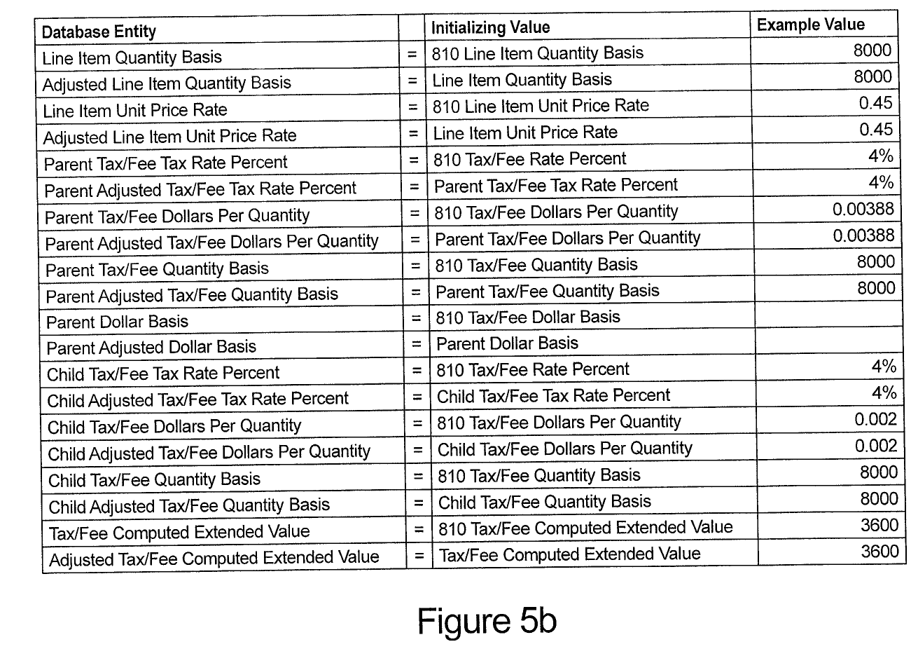

In the Example of FIG. 9, an error has been made—a purchase of 403 gallons has had two zeros added to it, and so appears as 40300 gallons. This error is detected by the payer user, whether manual or automatic, and may involve consideration of data stored in DATABASE 26, or elsewhere. The customer will need to correct this “line item” error by adjusting the invoice, and the system of the present invention will automatically adjust the ancillary charges associated with the line item. This procedure, and indeed the entirety of what is disclosed herein, may be better understood with reference to FIGS. 5A & 5B.

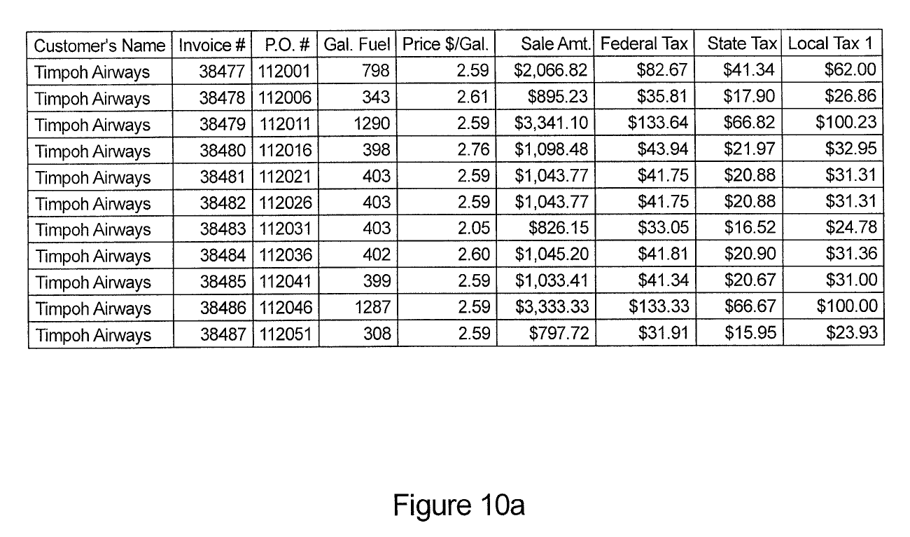

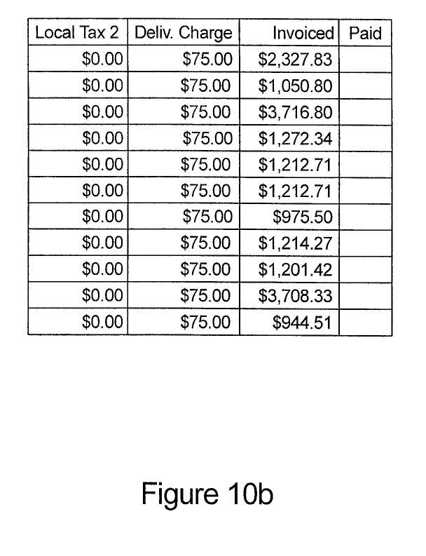

For exemplary purposes, it may be assumed that no executive jet has a fuel capacity greater than 1500 gallons, and the system may be configured with its adjustment rules (at 266) to reflect this, so as to automatically allow a customer to adjust any gallon amount greater than 2,000 gallons to 2, a lower amount, without the need for further permissions. Thus, the 40300 gallons invoiced in FIG. 9 may readily be adjusted to 403 gallons in accordance with the present invention, as discussed herein. The adjusted invoice is depicted in FIG. 10.

In one embodiment, source code may be written in an object-oriented programming language using relational databases. Such an embodiment may include the use of programming languages such as C++. Other programming languages which may be used in constructing a system according to the present invention include Java, HTML, PERL, UNIX shell scripting, assembly language, FORTRAN, Pascal, Visual Basic, and QuickBasic. Those skilled in the art will recognize that the present invention may be implemented in hardware, software, or a combination of hardware and software.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention as defined only by the hereinafter appended claims.

What is claimed is:

1. An electronic bill presentment and payment system for presenting an invoice of a vendor to a customer, the system comprising:
a) a billing database for storing an invoice file comprising a line value representing an amount payable by the customer for a product provided by the vendor and a tax value representing an amount payable by the customer as a tax on the product
b) an application server for:
i) receiving a request to adjust the line value from the customer;
ii) providing instructions to replace the line value with an adjusted line value;
iii) calculating an adjusted tax value based on the adjusted line value; and
iv) providing instructions to replace the tax value with the adjusted tax value.

2. The electronic bill presentment and payment system of claim 1, wherein the application server further provides MEANS for notifying the vendor of the adjusted line value and the adjusted tax value.

3. The electronic bill presentment and payment system of claim 1, wherein the invoice file further comprises a fee value representing an amount payable by the customer as a fee on the product, and the application server further provides for:
v) calculating an adjusted fee value based on the adjusted line value, and
vi) providing instructions to replace the fee value with the adjusted fee value.

4. The electronic bill presentment and payment system of claim 3, wherein the application server further provides for notifying the vendor of the adjusted line value, the adjusted tax value , and the adjusted fee value.

5. The electronic bill presentment and payment system of claim 4, wherein the invoice file further comprises a second line value representing an amount payable by the customer for a second product provided by the vendor, the tax value represents an amount payable by the customer as a tax on both the product and the second product, and the fee value represents an amount payable by the customer as a fee on both the product and the second product.

6. An electronic bill presentment and payment system for presenting an invoice of a vendor to a customer, the system comprising:
a) a billing database for storing an invoice file comprising a line value representing an amount payable by the customer for a product provided by the vendor and a tax value representing an amount payable by the customer as a tax on the product;
b) an adjustment file comprising adjustment parameters established by the vendor; and
c) an application server for receiving a request to adjust the line value from the customer, evaluating whether the request to adjust the line item is within the adjustment parameters, and if the request to adjust the line item is within the adjustment parameters:
i) providing instructions to replace the line value with an adjusted line value if the;
ii) calculating an adjusted tax value based on the adjusted line value; and
iii) providing instructions to replace the tax value with the adjusted tax value.

7. The electronic bill presentment and payment system of claim 6, wherein the application server further provides for notifying the vendor of the adjusted line value and the adjusted tax value.

8. The electronic bill presentment and payment system of claim 6, wherein the invoice file further comprises a fee value representing an amount payable by the customer as a fee on the product, and the application server further provides for:
v) calculating an adjusted fee value based on the adjusted line value, and
vi) providing instructions to replace the fee value with the adjusted fee value.

9. The electronic bill presentment and payment system of claim 8, wherein the application server further provides for notifying the vendor of the adjusted line value and the adjusted tax value.

10. The electronic bill presentment and payment system of claim 9, wherein the invoice file further comprises a second line value representing an amount payable by the customer for a second product provided by the vendor, the tax value represents an amount payable by the customer as a tax on both the product and the second product, and the fee value represents an amount payable by the customer as a fee on both the product and the second product.

11. A method for electronically presenting an invoice of a vendor to a customer, the method comprising:
a) receiving an invoice file from the vendor, the invoice file comprising a line value representing an amount payable by the customer for a product provided by the vendor and a tax value representing an amount payable by the customer as a tax on the product;
b) storing the invoice file in a data base;
c) providing the invoice file to the customer;
d) receiving a request to adjust the line value from the customer;
e) replacing the line value with an adjusted line value;
f) calculating an adjusted tax value based on the adjusted line value; and
g) replacing the tax value with the adjusted tax value.

12. The method for electronically presenting an invoice of a vendor to a customer of claim 11, further comprising notifying the vendor of the adjusted line value and the adjusted tax value.

13. The method for electronically presenting an invoice of a vendor to a customer of claim 11, wherein the invoice file further comprises a fee value representing an amount payable by the customer as a fee on the product, and the method further comprises:
h) calculating an adjusted fee value based on the adjusted line value, and
i) replacing the fee value with the adjusted fee value.

14. The method for electronically presenting an invoice of a vendor to a customer of claim 13, further comprising notifying the vendor of the adjusted line value and the adjusted tax value.

15. The method for electronically presenting an invoice of a vendor to a customer of claim 14, wherein the invoice file further comprises a second line value representing an amount payable by the customer for a second product provided by the vendor, the tax value represents an amount payable by the customer as a tax on both the product and the second product, and the fee value represents an amount payable by the customer as a fee on both the product and the second product.

16. A method for electronically presenting an invoice of a vendor to a customer, the method comprising:
a) receiving an invoice file from the vendor, the invoice file comprising a line value representing an amount payable by the customer for a product provided by the vendor and a tax value representing an amount payable by the customer as a tax on the product;
b) storing the invoice file in a data base;
c) providing the invoice file to the customer;
d) receiving a request to adjust the line value from the customer;
e) evaluating whether the request to adjust the line value is within adjustment parameters and if the request to adjust the line value is within the adjustment parameters:
i) replacing the line value with an adjusted line value;
ii) calculating an adjusted tax value based on the adjusted line value; and
iii) replacing the tax value with the adjusted tax value.

17. The method for electronically presenting an invoice of a vendor to a customer of claim 16, further comprising notifying the vendor of the adjusted line value and the adjusted tax value.

18. The method for electronically presenting an invoice of a vendor to a customer of claim 16, wherein the invoice file further comprises a fee value representing an amount payable by the customer as a fee on the product, and if the request to adjust the line value is within the adjustment parameters the method further comprises:
iv) calculating an adjusted fee value based on the adjusted line value, and
v) replacing the fee value with the adjusted fee value.

19. The method for electronically presenting an invoice of a vendor to a customer of claim 18, further comprising notifying the vendor of the adjusted line value and the adjusted tax value.

20. The electronic bill presentment and payment system of claim 19, wherein the invoice file further comprises a second line value representing an amount payable by the customer for a second product provided by the vendor, the tax value represents an amount payable by the customer as a tax on both the product and the second product, and the fee value represents an amount payable by the customer as a fee on both the product and the second product.
